(19) United States
(12) Patent Application Publication
(10) Pub. No.: US 2005/0046617 A1
(43) Pub. Date: Mar. 3, 2005

(54) Device and method for controlling flicker in liquid crystal shutter glasses

(76) Inventors: Stephen M. Kurtzer, Santa Barbara, CA (US); Jim Candy, Carpinteria, CA (US); Michael Weissman, Santa Barbara, CA (US)

Correspondence Address: Warren A. Sklar;Renner, Otto, Boisselle & Sklar, LLP, Nineteenth Floor, 1621 Euclid Avenue, Cleveland, OH, 44115-2191, US

(21) Appl. No.: 10/601,494

(22) Filed: Jun. 23, 2003

Related U.S. Application Data
(62) Division of application No. 09/298,118, filed on Apr. 23, 1999, now abandoned.

(51) Int. Cl. G09G 5/00

(52) U.S. Cl. 345/8

(57) ABSTRACT

Liquid crystal shutter glasses are used in time-sequential 3D systems to control which image the viewer's eyes receive. Worn by the viewer, they are designed to “open” and “close” to permit light to enter the eye or to block the light going to each eye synchronously with and in the same sequence as the right and left images are presented to a monitor or projector being viewed. If the refresh rate on the display device is slow, such as is the case in standard NTSC/PAL television systems, flicker will be observed by the viewer. For monitor displays, this flicker is due to flicker of the image on the monitor and/or flicker of the background illumination surrounding the monitor. The present invention provides liquid crystal shutter glasses adapted to reduce or eliminate flicker from both sources.

### BACKGROUND OF INVENTION

1. Field of the Invention

This invention relates to a device and method for reducing flicker perceived in an image viewed through liquid crystal shutter glasses.

2. Prior Art

Liquid crystal shutter glasses (LCSG) are used in time-sequential stereoscopic 3D systems to control which image the viewer's eyes receive. Worn by the viewer, they are designed to “open” and “close” (i.e., to transmit light or to block light going to each eye) synchronous with and in the same sequence as the left and right images are presented to a monitor or a projector. Only one shutter is open at a time. LCSG are usually designed for the “active-closed” configuration, that is, the shutter closes when a high voltage is applied. However, the principle set for thin this discussion apply equally to “active-open” configurations.

LCSG have three parts: 1) a “front” linear polarizer, 2) the LC cell, and 3) a “rear” linear polarizer. The front and rear polarizers are crossed, i.e., they are oriented 90 to each other for the “active-closed” design. For LCSG having an “active-open” design the orientation of the polarizers is parallel. In the open state, when no voltage is applied across the LC layer, the layer of LC material in the cell acts as a half-wave retarder. The LC layer rotates the axis of polarization of light passing therethrough by 90 degrees. Therefore, light passing through the first polarizer of the crossed polarizers passes through the second polarizer without significant attenuation. In the closed state, the LC does not rotate the polarization with the result that the light is then blocked by the crossed polarizers.

If the refresh rate on the screen of the display device is not fast enough, such as in standard NTSC/PAL television systems, flicker will be observed by the viewer. However, it is well known that flicker can be minimized by reducing the illumination of the viewed scene. One common method for doing this is to place a neutral density (ND) filter within the shutter glasses.

### SUMMARY OF THE INVENTION

It is a primary object of this invention to provide a device for viewing an image which reduces flicker in the image perceived by a viewer.

The features of the invention believed to be novel are set forth with particularity in the appended claims. However the invention itself, both as to organization and method of operation, together with further objects and advantages thereof may be best be understood by reference to the following description taken in conjunction with the accompanying drawings in which:

### BRIEF DESCRIPTION OF THE DRAWINGS

FIG. 1 is a schematic diagram showing a waveform commonly used to control the amount of light passing through liquid crystal shutter glasses.

FIG. 2 is a schematic diagram showing a second voltage waveform used to control the amount of light transmitted through liquid crystal shutter glasses to the eyes of a viewer.

FIG. 4 is a schematic diagram showing a modified voltage waveform applied to liquid crystal shutter glasses in accordance with the present invention.

FIG. 5 is a schematic diagram showing a modified voltage waveform applied to liquid crystal shutter glasses in accordance with the present invention.

FIG. 5 is a plan view of liquid crystal shutter glasses modified to provide the voltage waveforms shown in FIGS. 3 and 4.

FIG. 6 is an embodiment of the LCSG similar to the configuration of FIG. 5 wherein a screen-sized polarizer sheet is placed between the screen bearing the image being viewed a modified LCSG viewing device is employed.

### DESCRIPTION OF THE PREFERRED EMBODIMENT

LCSG are usually designed for the “active-closed” configuration, that is, the shutter closes when a voltage is applied. It is understood that the principles described for LCSG operating in the “active-closed” configuration described herein also apply to the “active-open” configuration.

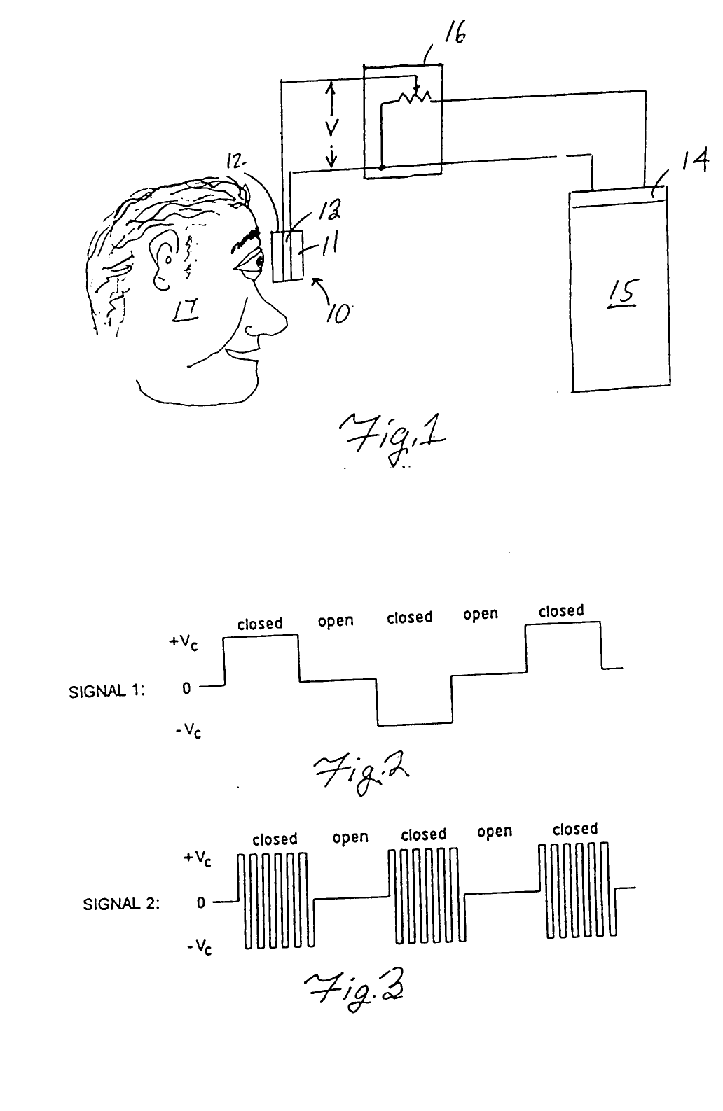

With reference to FIG. 1, LCSG lens 10 is comprised of front 11 and rear 12 crossed polarizers with an LC layer 13 therebetween. In the “active-closed” design, crossed linear polarizers 11 and 12 are placed on either side of a liquid crystal cell 13. In the open state, when no voltage is applied across the LC layer 55, the thin layer of LC material in the cell acts as a half-wave retarder, rotating the axis of polarization of the light passing therethrough by 90 degrees. Therefore, light can pass through the two polarizers providing maximum light transmission. A voltage signal V_{.} is applied across the LC layer 13 by means of a driver 14 which may be housed within a monitor 15. With reference now to FIGS. 2 and 3, in the “closed” state, when the “optimum” voltage V is applied, the magnitude of which will depend on the construction of the LC cell, the LC loses its retardation and does not rotate the polarization of light passing through the front polarizer 11. The light is blocked by the crossed polarizers, giving minimum transmission. For intermediate voltages, the rotation of the polarization is not complete, and the transmission of the cells is somewhere between the maximum and minimum states.

In a first embodiment of the present invention the voltage signal to the cell is controlled in such a way that the voltage applied in the “open” state is not zero (V_{.}). The open state remains dark to some degree. A variable resistor 16 may be interposed between the driver 14 and the lens 10 to act as a voltage divider. By varying this voltage between zero and some fraction of V., the user can control the amount of darkening and, consequently, the amount of flicker reduction. With reference now to FIGS. 2 and 3, there are two kinds of signals commonly employed to drive LC shutters: Signal 1, a low-frequency asymmetric signal; and Signal 2, a high frequency modulated signal. In a normal LCSG driver circuit, these signals take the forms shown in FIGS. 2 and 3. These traces show the signal going to one of the lenses which acts as a shutter. The other shutter (not shown in FIG. 1) is driven by identical signals, but 90 degrees out of phase for Signal 1 and 180 degrees out of phase for Signal 2. Positive and negative voltages have the same effect on the LC cell. The mean voltage of either signal is usually zero in order to prevent migration of the LC molecules.

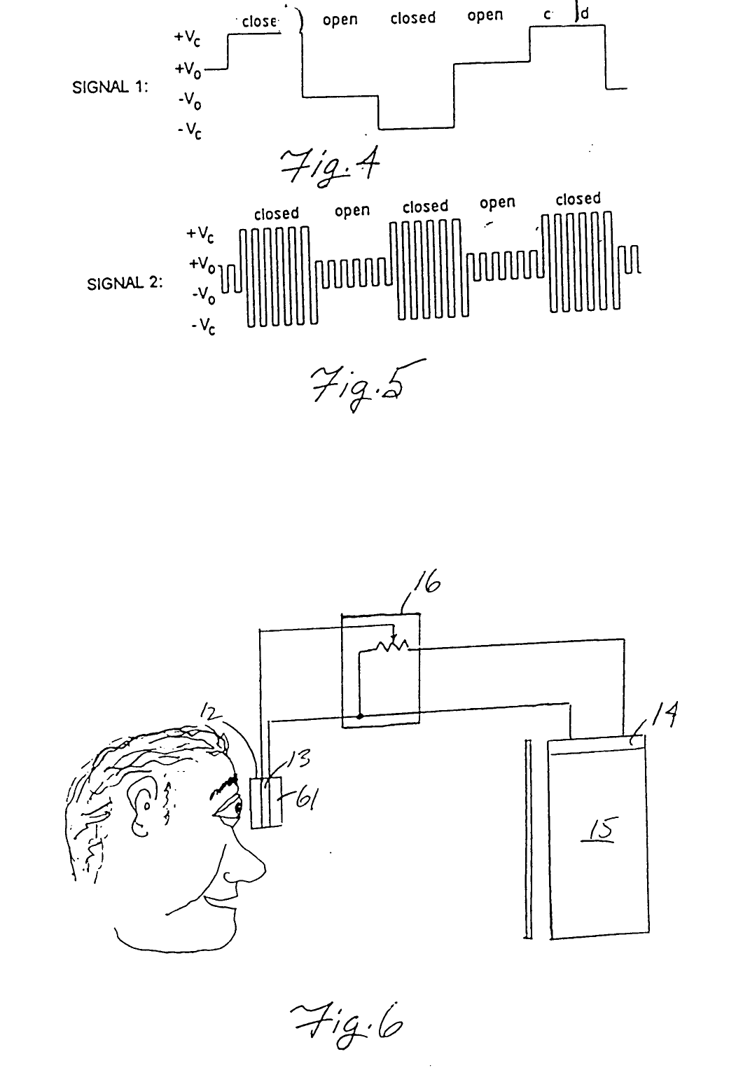

Electronic flicker control can be achieved by applying the signals having the form shown in FIGS. 4 and 5. V_{.} is changed to vary the amount of light transmission while the mean voltage remains zero. The foregoing embodiment of the invention thereby provides means to reduce flicker. Instead of placing neutral density (ND) filters over the shutters, the invention prevents the shutters from opening fully through an electronic control. Thus, ND filters are not required, and the viewer has complete control over the degree of darkening that any particular scene may require. This method and device is suitable for reducing flutter in many different types of LC shutter glasses.

A second embodiment of the present invention, illustrated in FIG. 6, provides a means of eliminating a portion of the flicker due to background illumination. The front polarizer, where light enters the shutter is removed and replaced with a transparent element 61. A polarizer 62 of the same orientation as polarizer 11 is placed over the screen of the monitor 15. Thus, light emanating from the screen and entering the LC cell will behave as before. The light will either pass through or be blocked by the shutter depending on the state of the cell, open or closed.

Light comprising background (i.e. light not emanating from monitor 15) will not be polarized when it enters the LC cell. However, not all of this light will pass through the shutter. Consider a shutter system where the front polarizer is vertical and the rear polarizer horizontal. When the shutter system is open, only the background light that is vertically polarized will pass through the shutter (after being rotated 90). When the shutter is closed (no rotation), only horizontally polarized entrance light will pass through. Thus the background illumination that enters the viewer's eye is continuously changing between two different polarizations. However, this does not cause flicker because it is balanced, i.e., of equal intensity. Except in rare circumstances, such as reflections from a shiny surface, the viewer 17 does not notice this change and does not perceive flicker.

While particular embodiments of the present invention have been illustrated and described, it will be obvious to those skilled in the art that various other changes and modifications can be made without departing from the spirit and scope of the invention. For example, the reference to LCSG operating in the “active-open” configuration is only used as an example of the invention and should not limit the scope of the invention. It is therefore intended to cover in the appended claims all such changes and modifications that are within the scope of this invention.

1. Liquid crystal shutter glasses adapted to be worn by a user and operable for presenting a visual image to the use by sequentially presenting left and right eye views of an image to the uses, the glasses comprising:
(a) a liquid crystal layer interposed between first and second polarizer layers;
(b) a voltage driver operable for applying alternating voltage across said liquid crystal layer and;
(c) voltage divider means operable for varying the amplitude of said voltage applied across said liquid crystal layer, said voltage divider means being disposed between said voltage driver and said crystal layer.

2. The liquid crystal shutter glasses of claim 1 wherein said voltage divider is a variable resistor.

3. Liquid crystal shutter glasses adapted to be worn by a user and operable for viewing a visual image on a screen wherein a first polarizer layer is disposed between said liquid crystal shutter glasses and the screen, said liquid crystal shutter glasses consisting essentially of a liquid crystal layer and a second polarizer layer.

4. The liquid crystal shutter glasses of claim 3 further comprising a voltage driver operable for alternating voltage across said liquid crystal layer.

5. The liquid crystal shutter glasses of claim 3 wherein said first polarizer layer is affixed to the screen.
